(19) United States
(12) Patent Application Publication
(10) Pub. No.: US 2005/0117325 A1
(43) Pub. Date: Jun. 2, 2005

(54) Desk lamp with function of generating negative ions

(76) Inventor: Hsin-Mao Hsieh, Pingtung City (TW)

Correspondence Address: TROXELL LAW OFFICE PLLC, SUITE 1404, 5205 LEESBURG PIKE, FALLS CHURCH, VA, 22041, US

(21) Appl. No.: 10/706,996

(22) Filed: Nov. 14, 2003

(51) Int. Cl. A61G 13/00

(52) U.S. Cl. 362/33

(57) ABSTRACT

A desk lamp with function of generating negative ions comprises a lamp body and a negative ion generator. The lamp body is consisted of a lamp base, a lamp arm and a lampshade. The negative ion generator is set on an internal wall inside the lamp body and has an air outlet plane toward a light region defined by the lampshade. The negative ion generator may be installed an appropriated position inside the lamp body, such as the lamp base, the lamp arm or the lampshade, so that negative ions from the negative ion generator will be exhausted outside the lamp body.

### FIELD OF THE INVENTION

The present invention is relating to a desk lamp, particularly to a desk lamp with function of generating negative ions.

### BACKGROUND OF THE INVENTION

Conventionally a desk lamp is only with lighting function. It should be improving the air condition surrounding the desk for increasing the reading efficient. A conventional portable negative ion generator had been brought from TW Patent Publication No. 337710. Size of the portable negative ion generator should be as little as possible to carry easily, but, if the portable negative generator is too small, it is easy to lose. Meanwhile, if the portable negative ion generator leaves reader's head too far, the negative ions would be dilute and its help would be decreased.

An electrical light bulb with function of generation negative ions and economizing energy is disclosed in TW Patent Publication No. 423704. The electrical light bulb comprises a contact base connecting with a bulb body. A negative ion generator is installed in the contact base. Because that the life time of the light bulb is regular, the expensive negative ion generator would be abandoned when the light bulb is out of the life time. Also, specifications of the light bulb and conventional bulb are not interchangeable.

### SUMMARY OF THE INVENTION

A primary object of the present invention is to provide a desk lamp with function of generating negative ions. An air outlet plane of a negative ion generator is installed and toward internal wall of a lamp body to improve the atmosphere around the desk lamp for increasing reading efficient and not easy to lose.

A second object of the present invention is to provide a desk lamp with function of generating negative ions. An air outlet plane of a negative ion generator is installed and toward internal wall of a lamp body, and a fan is set on a air inlet plane of the negative ion generator, so that negative ions from the negative ion generator is exhausted outside the lamp body.

According to the invention, the desk lamp with function of generating negative ions mainly comprises a lamp body and a negative ion generator. The lamp body is consisted of a lamp base, a lamp arm and a lampshade. The negative ion generator has a air outlet plane toward internal wall of the lamp body and is installed at an appropriated position inside the lamp base, the lamp arm or the lampshade, so that negative ions made from the negative ion generator will be exhausted outside the lamp body. Perfectly, an air inlet plane of the negative ion generator is installed with a fan for exhausted the negative ion outside the lamp body easily.

### DESCRIPTION OF THE DRAWINGS

FIG. 1 is a schematic 3-D view of a desk lamp with function of generating negative ions of a first embodiment of the present invention;

FIG. 2 is a schematic side view of a desk lamp with function of generating negative ions of the first embodiment of the present invention;

FIG. 3 is a schematic 3-D view of a desk lamp with function of generating negative ions of a second embodiment of the present invention;

FIG. 4 is a schematic 3-D view of a desk lamp with function of generating negative ions of a third embodiment of the present invention;

FIG. 5 is an exploded perspective view of a desk lamp with function of generating negative ions of a fourth embodiment of the present invention;

FIG. 6 is a schematic side view of a desk lamp with function of generating negative ions of the fourth embodiment of the present invention;

FIG. 7 is a schematic side view of a desk lamp with function of generating negative ions of a fifth embodiment of the present invention; and

FIG. 8 is a schematic side view of a desk lamp with function of generating negative ions of a sixth embodiment of the present invention.

### DETAIL DESCRIPTION OF THE INVENTION

Referring to the drawings attached, the present invention will be described by means of the embodiment below.

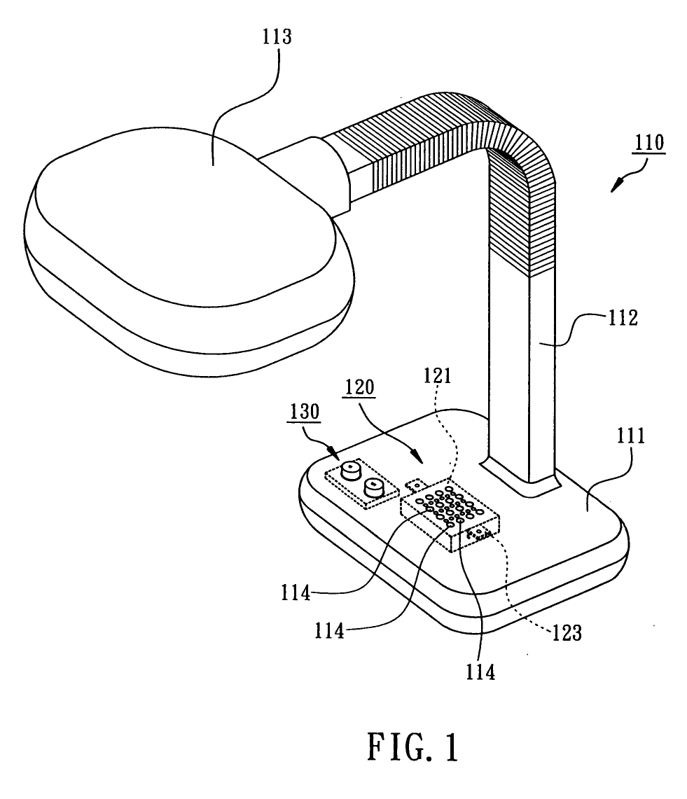

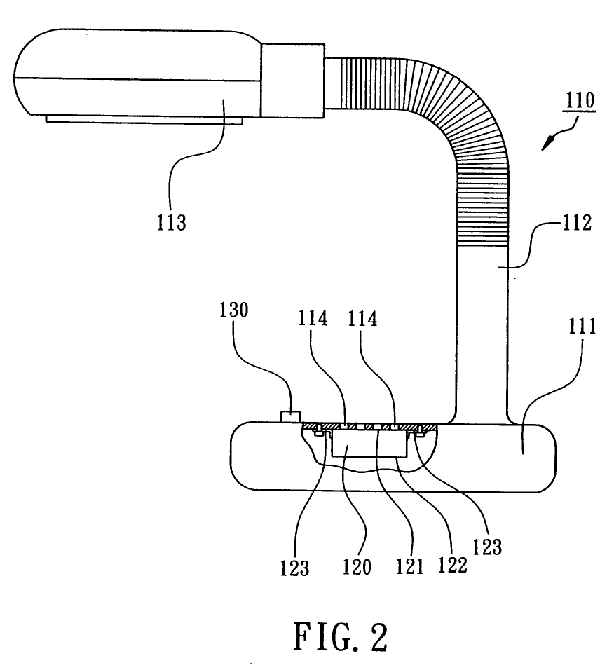

According to a first embodiment of the present invention showed in FIGS. 1 and 2, a desk lamp with function of generating negative ions main comprises a lamp body 110 and a negative ion generator 120. The lamp body 110 is consisted of a lamp base 111, a lamp arm 112 and a lampshade 113. The lamp base 111 is a base of the desk lamp for placing on the desk. A power switch 130 is set on the lamp base 111 for controlling the light source and the negative ion generator 120. The lamp arm 112 connects the lamp base 111 with lampshade 113. The lampshade 113 has connector for installing a lamp tube or a light bulb. The negative ion generator 120 is installed at an appropriated position inside the lamp body 110. The negative ion generator 120 comprises driving circuits and negative ion discharging electrodes (not show in the drawings). Theory of forming negative ion generator 120 is commonly known and thus not described in detail herein. In this embodiment, the negative ion generator 120 is installed on internal wall of the lamp base 111. The negative ion generator 120 has an air outlet plane 121 and a air inlet plane 122, wherein two sides of the air outlet plane 121 forms a plurality of connecting portions 123 for fixing the air outlet plane 121 toward internal wall of the lamp base 111, so that negative ions from the negative ion generator 120 will be exhausted outside the lamp body 110. Preferably, the air outlet plane 121 of the negative ion generator 120 is attached on the internal wall of the lamp base 111 for avoiding air turbulence. Therefore, the desk lamp with function of generating negative ions will increase reading efficient of reader at front of the desk lamp.

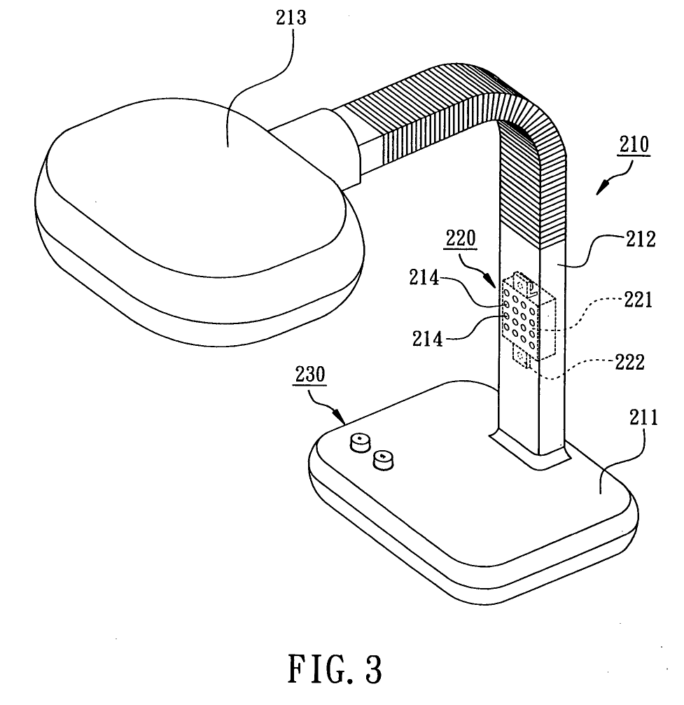

In addition, according to the present invention the negative ion generator could be installed in other position inside a lamp body. Pleases referring FIG. 3, a desk lamp with function of generating negative ions according to a second embodiment of the present invention mainly comprises a lamp body 210 and a negative ion generator 220 which structure is as same as the negative ion generator 120 described in the first embodiment. The lamp body 210 is consisted of a lamp base 211, a lamp arm 212 and a lampshade 213. A power switch 230 is set on the lamp base 211. The lampshade 213 is a light source to define a light region. The negative ion generator 220 has an air outlet plane 221 and connecting portions 222 at perimeters of the air outlet plane 221. The negative ion generator 220 is installed on internal wall inside the lamp arm 212 by the connecting portions 222, and the air outlet plane 221 is toward the light region of the desk lamp to improve the atmosphere for increasing reading efficient.

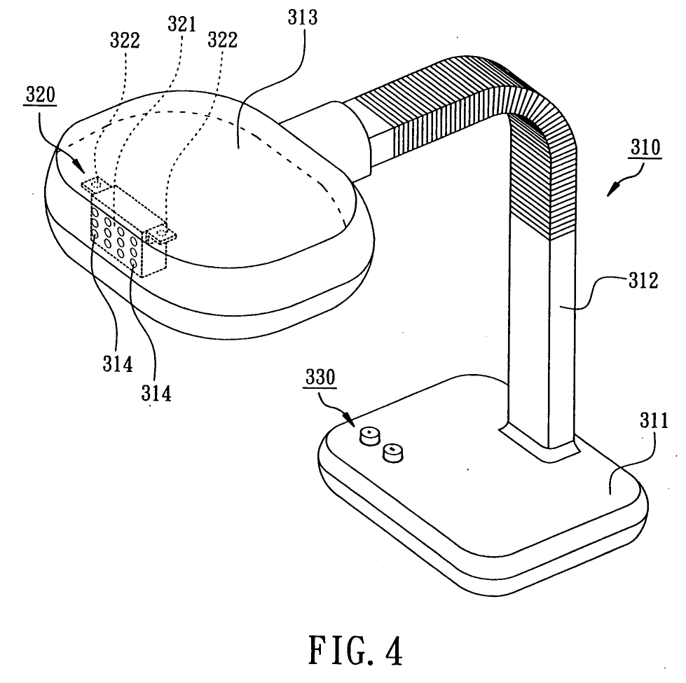

Referring FIG. 4, a desk lamp with function of generating negative ions according to a third embodiment of the present invention main comprises a lamp body 310 and a negative ion generator 320. Structures of a lamp base 311, a lamp arm 312, a lampshade 313 and a power switch 330 are as same as the lamp base 111, the lamp arm 112, the lamp shade 113 and the power switch 130 in the first embodiment, and thus not described in detail herein. The lame shade 313 has a plurality of air outlet holes 314. The negative ion generator 320 is installed in an internal wall inside the lamp shade 313 and has a air outlet plane 321 corresponding to the air outlet holes 314. Two sides of the air outlet plane 121 forms connecting portions 322 to connect to the lampshade 313.

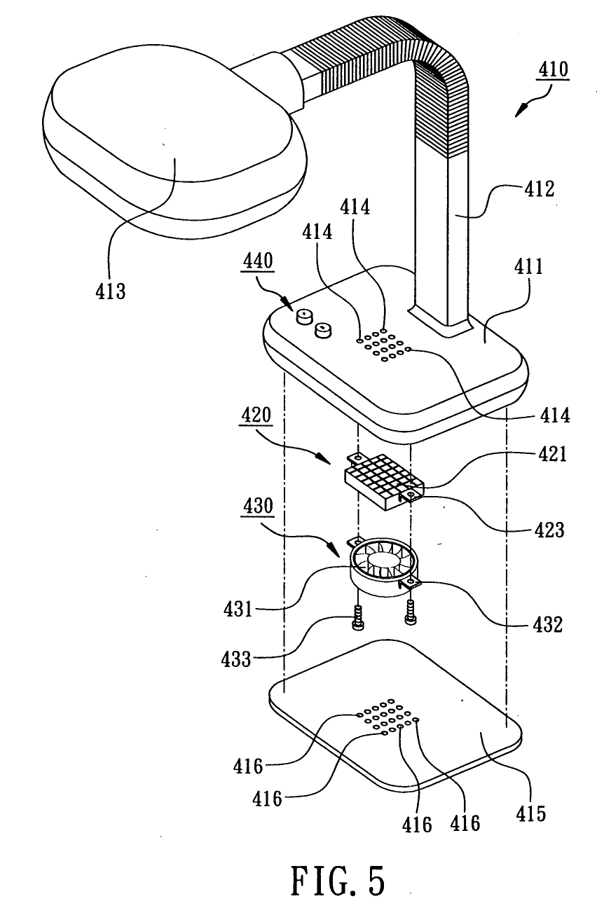

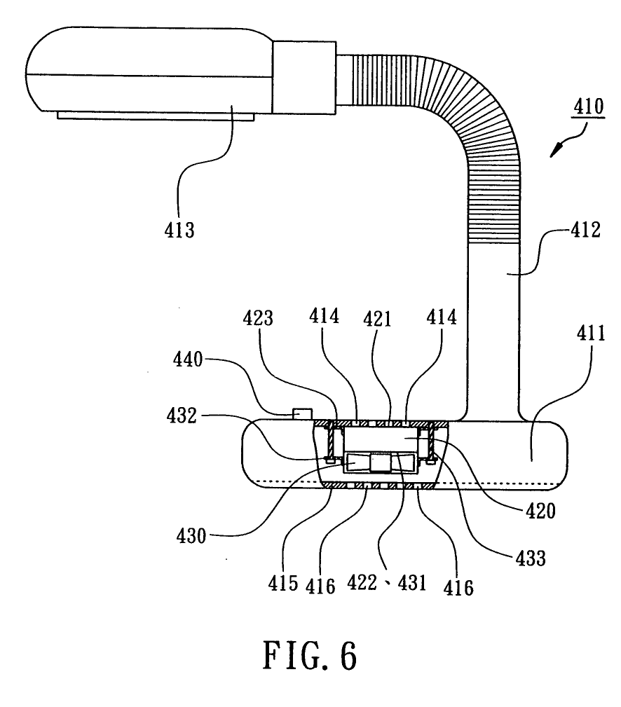

Referring FIGS. 5 and 6, a desk lamp with function of generating negative ions according to a fourth embodiment of the present invention comprises a lamp body 410 and a negative ion generator 420, which structures are similar to the lamp body 110 and a negative ion generator 120 in the first embodiment. The desk lamp with function of generating negative ions further comprises a fan 430 which is like a D/C brushless fan or a common micro fan. The lamp body 410 is consisted of a lamp base 411, a lamp arm 412 and a lampshade 413. The lamp base 411 has a plurality of air outlet holes 414 and sets a power switch 440. A plate 415 with a plurality of air outlet holes 416 is setting at bottom of the lamp base 411. The negative ion generator 420 and the fan 430 are installed inside the lamp base 411. In this embodiment, an air outlet plane 421 of the negative ion generator 420 is corresponding to the air outlet holes 414 of an internal wall of the lamp base 411 toward light region defined by the lamp shade 413. And an air inlet plane 422 of the negative ion generator 420 is corresponding to a wind outlet 431 of the fan 430. The fan 430 has a plurality of connecting portions 432 and installed on internal wall of the lamp base 411 through the negative ion generator 420 by a plurality of bolts 433 or other fixing elements. The negative ion generator 420 has a plurality of connection portions 423 and installed on the internal wall of the lamp base 411 by the bolts 433 or fixing elements. When the fan 430 is operating, the negative ions from the negative ion generator 420 will be exhausted outside the lamp base 411 toward the light region easily.

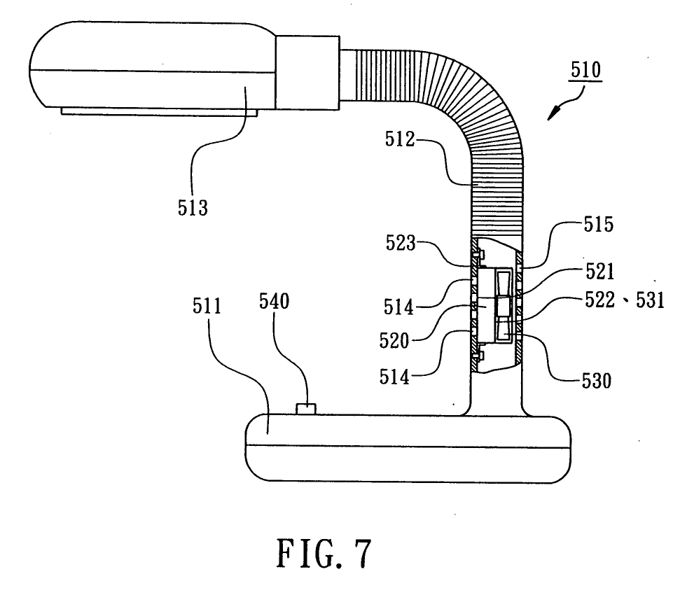

Referring FIG. 7, a desk lamp with function of generating negative ions of a fifth embodiment of the present invention comprises a lamp body 510 and a negative ion generator 520 which structures are similar to the lamp body 210 and a negative ion generator 220 in the second embodiment, wherein the negative ion generator 520 is installed in a lamp arm 512 of the lamp body 510. The desk lamp with function of generating negative ions further comprises a fan 530 with a wind outlet 531 which is corresponding to an air inlet plane 522 of the negative ion generator 520. Preferably, the negative ion generator 520 and the fan 530 are combined together to be a module for installing inside the lamp arm 512 easily. The lamp arm 512 connects the lamp base 511 with lampshade 513, and has a plurality of air inlet holes 515 and a plurality of air outlet holes 514. The air outlet holes 514 are corresponding to an air outlet plane 521 of the negative ion generator 520. The negative ion generator 520 has a plurality of connecting portions 523 for be fixed on internal wall of the lamp arm 512. The negative ion generator 520 can be opened or closed droved by a power switch 540 set on the lamp base 511. When the fan 530 is operating, the negative ions from the negative ion generator 520 will be exhausted outside the lamp arm 512 smoothly.

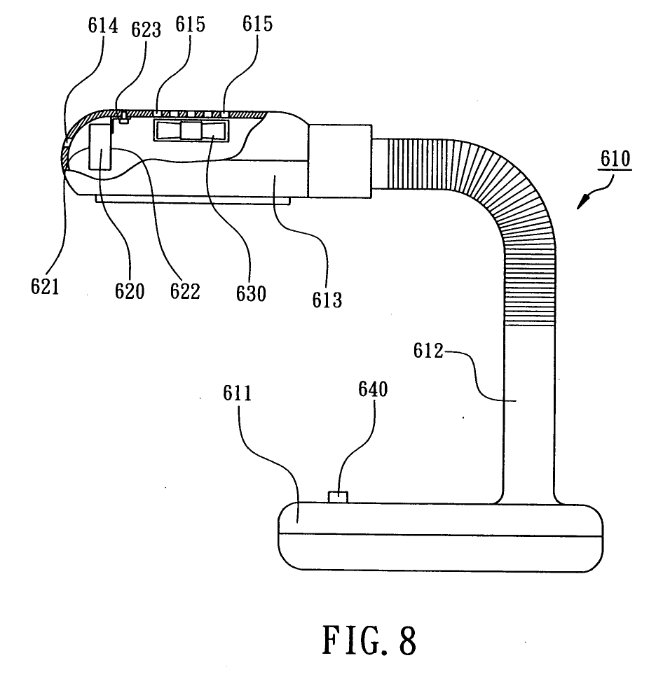

Referring FIG. 8, a sixth embodiment is almost the same as the third embodiment of the present invention, comprising a negative ion generator 620 and a lamp body 610 which is consisted of a lamp base 611, a lamp arm 612 and a lampshade 613 as same as the negative ion generator 320 and the lamp body 310 in the third embodiment. But the sixth embodiment of the present invention further discloses an independent fan 630. The negative ion generator 620 and the independent fan 630 are installed inside the lampshade 613 but not combined together. The lampshade has a plurality of air outlet holes 614 and a plurality of air inlet holes 615. When the fan 630 is operating, air outside the lampshade 613 will be suck in the lamp shade 613 by passing through the air inlet holes 615 and the negative ions from the negative ion generator 520 will be exhausted outside the lampshade 613 through the air outlet holes 614. The generated negative ions are close to reader by passing through the air outlet holes 614 for increasing reading efficiency.

The above description of embodiments of this invention is intended to be illustrated and not limiting. Other embodiments of this invention will be obvious to those skilled in the art in view of the above disclosure.

1. A desk lamp with function of generating negative ions comprising:
a lamp body having a lamp base, a lamp arm and a lampshade; and
a negative ion generator having an air outlet plane on an internal wall inside the lamp body and installed an appropriated position inside the lamp body.

2. The desk lamp with function of generating negative ions of claim 1, further comprising a fan connected with the negative ion generator.

3. The desk lamp with function of generating negative ions of claim 2, wherein the fan has a plurality of connecting portions for fixing the fan through the negative ion generator.

4. The desk lamp with function of generating negative ions of claim 1, wherein the negative ion generator has a plurality of connecting portions at two sides of the air outlet plane.

5. The desk lamp with function of generating negative ions of claim 1, wherein the negative ion generator is installed on the internal wall inside the lamp base.

6. The desk lamp with function of generating negative ions of claim 1, wherein the negative ion generator is installed on the internal wall inside the lamp arm.

7. The desk lamp with function of generating negative ions of claim 1, wherein the negative ion generator is installed on the internal wall inside the lamp shade.

8. The desk lamp with function of generating negative ions of claim 1, wherein the air outlet plane is attached on the internal wall.

9. The desk lamp with function of generating negative ions of claim 1, wherein the lampshade defines a light region, the air outlet plane is toward the light region.
